(19) United States
(12) Patent Application Publication
(10) Pub. No.: US 2003/0041029 A1
(43) Pub. Date: Feb. 27, 2003

(54) Method of producing revenues online

(76) Inventor: James B. Gould, York Harbor, ME (US)

Correspondence Address: John A. Hamilton, III, Choate, Hall & Stewart, 53 State Street, Exchange Place, Boston, MA, 02109, US

(21) Appl. No.: 09/934,253

(22) Filed: Aug. 21, 2001

(51) Int. Cl. G06F 17/60

(52) U.S. Cl. 705/50

(57) ABSTRACT

A method of and system for generating revenue online, wherein the method comprises providing a secure and privacy protected Internet accessible web site to an online community having members with an interest in a particular professional association, and exchanging for value with one or more entities a right for a predetermined amount of time to provide to the members expertise related to the professional association via the online community. Preferably, the members comprise potential customers with whom the entities may develop personal relationships. The present invention allows two or more parties to network simultaneously with a great number of their professional peers. The parties will be solicited to join the community, provided they meet certain screening criteria. Certain parties may be granted an exclusive right to serve as a community expert. The exclusive or non-exclusive right will be granted for a predetermined period of time, during which the community expert will abstain from overt marketing practices, and generally be available as a resource for providing answers to the members' questions and as a mentor for members requiring assistance.

### FIELD OF THE INVENTION

The present invention relates generally to providing a method for persons and entities related to a particular professional association to interact and build professional and personal relationships. The invention provides a model for deriving revenue by selling to entities a right to provide expertise to members of a secure online community dedicated to the particular professional association. The method has broad applicability, in that the particular professional association may comprise any non-profit or for-profit organization, or any professional discipline, such as hospital management or accounting.

### BACKGROUND OF THE INVENTION

There is a greater and greater demand from professionals for avenues through which they may candidly discuss issues and concerns related to their field(s) of endeavor. Conferences and seminars provide some ability to meet peers and have individual discussions. Time is often limited, however, at such gatherings which occasionally results in interactions not being as inclusive in terms of numbers of attendees as well as in terms of range of viewpoints on particular topics. There is also a need among persons or entities, be they providers of some service for profit or not for profit, to establish relationships and networks with the types of professionals mentioned above. Such entities expend vast amounts of money soliciting customers through various inefficient means.

The use of computer communications over vast public and private networks has created new opportunities and new obstacles. While a truly huge amount of information is now accessible devoted to particular interests or professions, it has become more challenging to find such information without exhaustively searching through unhelpful information. Computer networks allow the establishment of online virtual communities that in turn provide an avenue for the two classes of individuals and entities described above to associate.

Several of the revenue generation models surrounding such communities involve, obtaining personal information about a party seeking a service or a forum, then selling and reselling the party's personal information to marketers. Technology also exists for monitoring the browsing behavior of the party in order to develop a profile type for that party, which may also be sold. This often results in many unwanted marketing solicitations and a loss of control over the party's own personal information. Other revenue models include fees paid for direct advertising upon the online community site, and fees-for-advice structures.

Thus, a need exists by which an individual may seek advice or share ideas with a large number of peers without accruing a cost, in terms of having to pay a membership fee or in terms of relinquishing control over his or her personal information or anonymity. A solution that simultaneously generates revenue for the host of the online community, taking advantage of the service providers' desires to spend its marketing resources in a highly targeted manner, would be beneficial for all parties involved.

### SUMMARY OF THE INVENTION

It is an object of the invention to address the needs described above. To this end, the invention is directed to a method of generating revenue online, comprising the steps of providing a secure and privacy protected Internet accessible web site to an online community having members with an interest in a particular professional association, and exchanging for value with one or more entities a right for a predetermined amount of time to provide to the members expertise related to the professional association via the online community. Preferably, the members comprise potential customers with whom the entities may develop personal relationships.

The present invention allows two or more parties to network simultaneously with a great number of their professional peers. The parties will be solicited to join the community, provided they meet certain screening criteria. Certain parties may be granted an exclusive right to serve as a community expert. The exclusive or non-exclusive right will be granted for a predetermined period of time, during which the community expert will abstain from overt marketing practices, and generally be available as a resource for providing answers to the members' questions and as a mentor for members requiring assistance.

### BRIEF DESCRIPTION OF THE DRAWING

FIG. 1 is a block diagram depicting an embodiment of a system for generating revenues online according to the present invention.

### DETAILED DESCRIPTION

Preferred embodiments of the invention will now be described with reference to the accompanying drawings.

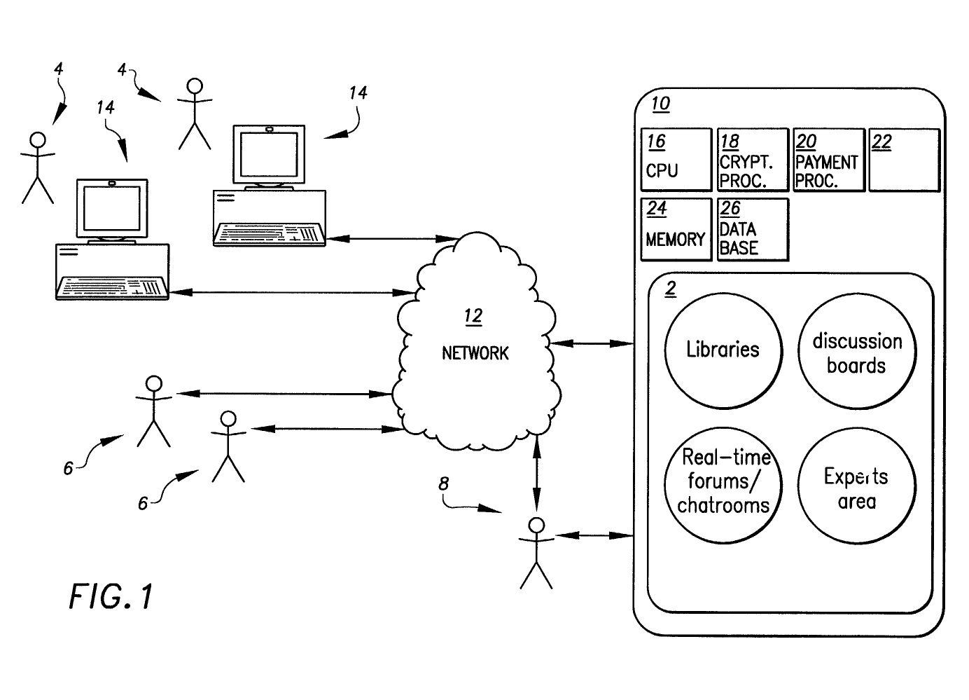

The present invention is directed to a novel method of generating revenue by facilitating the establishment of relationships among professionals and persons and/or entities sharing a common professional interest. The steps of the method include providing a secure and privacy protected community web site 2, such as depicted in FIG. 1, through which an online community may be formed. The community web site 2 serves as a forum for members 4 and sponsors 6 to hear and be heard by their peers. Potential new members will be actively recruited for a free membership in the online community, provided they meet certain membership criteria. Revenue is generated primarily by selling to the sponsors 6 a right to serve as “experts” for the members 4 of the online community.

The community web site 2 is created and maintained by a community service provider 8. The community web site 2 is implemented on at least one conventional personal computer or web server 10 accessible through a network 12. The network 12 may comprise a wide area network such as the internet, or a local area network. The web server 10 and network 12 support a broad variety of multimedia communications, including video and instant messaging, and is adapted to incorporate new technology as it becomes available. Typically, members 4 will access by their member computers 14 the network 12 and community web site 2 using a wired or a wireless transfer medium. Alternative carrier systems such as cable and satellite communication systems, and hand-held computing devices are also within the scope of the invention.

The web server 10 is comprised generally of central processing unit(s) 16, cryptographic processors 18, payment processors 20, one or more communication or network interfaces 22, and computer memory 24. The cryptographic processors 18 may execute any number of known cryptographic applications in directing communications to and from members 4 and sponsors 6 in a secure and privacy-protected manner. The cryptographic processors interact with a membership database 26 to determine if a user belongs to the community. If it is determined a user belongs to a community, the user is given the opportunity to enter the community. The user may then access the home (start) page for the community. The payment processors 20 will execute applications directed to accepting payment from the sponsors 6. The computer memory 24 will store for later retrieval numerous data, such as member personal information, routing and cryptographic key data, all discussion thread postings, all library and database information, and any other information provided by the sponsors 6 or service provider 8. The computer memory 24 may be comprised of any conventional storage means.

The web server 10 will provide members access to textual, video and audio educational tools, reference libraries, discussion threads, and real-time streaming presentations and/or discussions moderated by the sponsor(s) 6 serving as community experts. Although it is expected that members 4 will complete a registration form providing certain personal data, the privacy of this data will be strongly maintained and not shared, sold, or transferred in any way by the web site provider 8. Additionally, electronic access to the community web site 2 will be provided via cryptographic techniques, such as Secure Socket Layer. Furthermore, each of the members 4 will be provided a member name by which his or her true identity will be protected, and which he or she may use in sending and receiving communications with other members or sponsors. Each member has the option to reveal his or her true identity to any other member or sponsor. Additionally, the activity of the member browsing through the community web site 2 will preferably not be monitored for profiling purposes, though monitoring for conformance to community rules may be performed. Personal computer conferencing, such as “chat rooms”, may be employed to allow a large number of member to participate in a presentation or conference moderated by a sponsor. Bulletin boards may also be employed, enabling any member to start or respond to discussion threads and reach many times more peers than would be possible at a seminar or conference.

Exemplary professional associations of interest could include fund raising executives, hospital development, hospital administration, hospital financing, nursing, hospital dietetics, orthopedic hospital development, accounting, law, sports, travel servicing, fundraising, career counseling, advertising, etc. In actuality, any community comprised of members with a common professional interest and/or specific-interest organizations (non-profit and for-profit) may be served by the present invention. This could include business entities of any size, or organizations such as the American Medical Association. An online community in accordance with the present invention is somewhat of a marriage between an institution or organization and a professional provider.

The online community provides a means for members 4 to develop personal relationships as well as professional. For example, in an online community devoted to the medical profession in accordance with the present invention, a physician member may communicate with another physician about domestic stress caused by long hours, about a mutual interest in sailing, about the best office management tools, or any other issue of mutual interest.

Membership in the online community is free, but individuals seeking membership may be required to meet certain screening criteria. In one embodiment, prospective members must be nominated or recommended by one or more existing members. Additional screening criteria may comprise experience and/or educational qualifications, holding or having held a position within an organization, or membership in a profession or professional society. In another embodiment, rewards or incentives may be created for present members who succeed in bringing qualified new members into the online community.

The web site provider 8 will be responsible for actively encouraging individuals to apply for membership, accepting or rejecting membership applications, providing access to the web site for accepted members, and maintaining the security and privacy elements of the web site. The web site provider will also provide a site development professional who will introduce topics, split off topics, and monitor conformity to community rules.

An advantage of the current invention, is that revenue for maintaining the community is not generated through membership fees or the entity or organization to which the community is devoted, but is instead derived from sponsors 6 who recognize an opportunity to finely target for relationship-building a carefully selected group of potential customers or peers. In one embodiment, some of the generated revenue is even shared with the organization or association to which the online community is devoted.

The sponsors 6 pay for the right to serve as an expert for the online community for a predetermined amount of time. Sponsors may serve as expert moderators of both real-time discussions as well as issue-specific bulletin boards. The advice provided will be attributed to a particular sponsor, thereby allowing the perhaps previously unknown sponsor's credibility and standing as an authority on the particular topic to grow. Sponsors may serve as mentors to members, fostering professional and personal relationships among peers and potential customers. Sponsors may also serve as joint promoters of topic-specific events, in order to become identified with the specific topic. At any point in time, there may be one or more sponsors having been sold a right to be an expert.

In an alternative embodiment, the right to serve as an expert is sold exclusively to one sponsor for a predetermined period of time. In a preferred embodiment, the predetermined period during which the sponsor may serve as an expert is approximately three months, however longer or shorter period could be sold. During this period, the sponsor generally agrees to certain conditions. One such condition is that the sponsor will abstain from overt marketing practices targeting the members. Another is that the sponsor will provide expertise including responses to members' questions posted in dedicated discussion threads accessible to all members. Another is that the sponser will make available to the members via the telephone a knwledgeable person for responding to member's questions.

Other embodiments of the inveniton will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of generating revenue online, comprising the steps of:
providing a secure and privacy protected Internet accessible web site to an online community having members with an interest in a particular professional association; and
selling to one or more entities the right for a predetermined amount of time to provide to the members expertise related to the professional association via the online community.

2. The method of claim 1, wherein the members comprise potential customers with whom the entities may develop personal relationships.

3. A method of allowing two or more parties to network, the method comprising the steps of:
providing a secure and privacy protected Internet accessible web site for an online community dedicated to a professional association;
soliciting one or more persons to become members of the online community;
providing secure and anonymous access to persons selected for free membership to the Internet site; and
exchanging for value with one or more sponsors a right to provide expertise related to the professional association via the online community for a predetermined amount of time.

4. The method of claims 1 or 3, wherein the right to provide expertise is an exclusive right provided to one sponsor.

5. The method of claims 1 or 3, wherein the professional association comprises a professional discipline.

6. The method of claims 1 or 3, wherein the professional association comprises a non-profit entity.

7. The method of claims 1 or 3, wherein the professional association comprises a for-profit entity.

8. The method of claims 1 or 3, wherein further comprising the step of:
selecting persons for admission as members based upon the recommendation of previously admitted members and additional screening criteria.

9. The method of claim 8, wherein the additional screening criteria includes membership in the professional association.

10. The method of claims 1 or 3, wherein the predetermined amount of time is at least three months.

11. The method of claims 1 or 3, wherein providing expertise includes abstaining from overt marketing practices targeting the members.

12. The method of claims 1 or 3, wherein providing expertise includes responding to members' questions in a dedicated discussion thread accessible to all members.

13. The method of claims 1 or 3, wherein providing expertise includes making available a knowledgeable person to respond to members' questions via the telephone.

14. The method of claims 1 or 3, wherein providing expertise includes hosting a live online chat conference on a particular topic of interest to the members.

15. The method of claims 1 or 3, wherein the members may optionally provide their personal information to other members or sponsors in the online community.

16. The method of claims 1 or 3, further comprising the step of:
sharing with the professional association the exchanged-for value obtained from the one or more sponsors.
